(19) United States
(12) Patent Application Publication
(10) Pub. No.: US 2024/0041696 A1
(43) Pub. Date: Feb. 8, 2024

(54) AUTOMATED CARDIOPULMONARY RESUSCITATION DEVICE

(71) Applicant: The Feinstein Institutes for Medical Research, Manhasset, NY (US)

(72) Inventors: Lance Becker, Port Washington, NY (US); Allison Cohen, Long Island City, NY (US); Timmy Li, Fresh Meadows, NY (US); Daniel Rolston, Garden City, NY (US)

(21) Appl. No.: 18/229,495

(22) Filed: Aug. 2, 2023

Related U.S. Application Data
(60) Provisional application No. 63/394,468, filed on Aug. 2, 2022.

(51) Int. Cl. A61H 31/00

(52) U.S. Cl. CPC A61H 31/006; A61H 31/008; A61H 2201/1619; A61H 2230/255; A61H 2201/5048; A61H 2201/0119; A61H 2201/1207; A61H 2230/405; A61H 2230/201; A61H 2201/10

(57) ABSTRACT

A device for delivering chest compressions for performing cardiopulmonary resuscitation includes a compression assembly and chest contact pad that can be positioned over the thorax of a patient experiencing a cardiac arrest. The compression assembly is supported by a frame and one or more positioning mechanisms for moving the compression assembly relative to the patient's left ventricle. A controller causes the compression assembly to deliver a plurality of chest compressions to the patient. A blood flow monitor, such as a Doppler ultrasound monitor, is coupled with the patient's femoral or carotid artery to monitor the flow of arterial blood when chest compressions are delivered and to communicate blood flow parameter information to the controller. The controller causes the positioning mechanism to move the location where the compressions are delivered to optimize the blood flow parameters. The controller monitors the blood flow parameters to determine the occurrence of a return to spontaneous circulation (ROSC). When ROSC is detected, the controller causes the compression assembly to cease chest compressions.

This application claims priority benefits from U.S. Provisional Patent Application No. 63/394,468, filed on Aug. 2, 2023, the disclosure of which is incorporated herein by reference.

### FIELD

The disclosure is related to a mechanical chest compression device for performing Cardiopulmonary Resuscitation (CPR) to improve patient outcomes during and following cardiac arrest. In particular, the disclosure related to an integrated closed-loop system with a blood flow detector that monitors blood flow in response to chest compressions and adjusts the operation/location of the CPR device to improve the efficacy of the compressions. This disclosure further relates to such a close-loop system that detects return of spontaneous circulation (ROSC) and ceases chest compressions in response to the detected ROSC.

### BACKGROUND OF THE DISCLOSURE

International guidelines highlight the importance of high-quality chest compressions during CPR, which are defined as compressions at a depth of 5 cm-6 cm and a rate of 100-120 compressions per minute, allowing full chest recoil between compressions, and minimization of interruptions. Despite consistent observational data showing the association between CPR quality and patient outcomes, the delivery of high-quality manual chest compressions is challenging in both the out-of-hospital and in-hospital settings. Specific barriers include provider fatigue, physical effort to overcome stiffness of the patient's thoracic cage, and compressible underlying surfaces, such as mattresses, which can lead to shallow chest compressions. For example, in one study of 9,136 patients suffering out-of-hospital cardiac arrest (OHCA), only 45% received the recommended guideline chest compression depth.

It has been found that applying CPR at a rate of 107 compressions per minute at a depth of 4.7 cm (about 2 inches) in the first five minutes of CPR can be associated with significantly improved outcomes when Emergency Medical Services (EMS) rescuers are treating cardiac arrest outside the hospital. The efficacy of this combination of compression rate and depth of compression may not significantly vary when analyzed according to age, sex, presenting cardiac rhythm or the use of a specialized device attached to the airway during CPR. It has been found that the use of a mechanical chest compression device significantly improved outcomes when the target combination of rate and depth was utilized. When CPR was performed within 20% of those chest compression values, it has been found that neurologically intact survival was significantly higher (6.0% vs. 4.3%) than outside that range. Considering an estimated 300,000 or more out-of-hospital cardiac arrests occur each year nationally, these findings could translate into thousands of additional lives being saved annually in the United States alone and perhaps more if the target combination could be achieved routinely.

High-quality chest compressions are a critical component in the cardiac arrest chain of survival. Yet, despite its importance, the sustained delivery of high-quality CPR may not be achieved consistently in clinical practice. Achieving the optimal CPR protocol by applying manual chest compressions may be difficult due to physical limitations of rescuers. Mechanical devices are not subject to the physical limitations of the rescuer and may be better able to deliver high-quality chest compressions.

Under some circumstances mechanical chest compression devices deliver high-quality external chest compressions in place of a human rescuer. Known mechanical chest compression devices deliver chest compressions either by positioning a piston-driven cup over the chest of the patient or by providing a contracting band that surrounds the chest. The cup or band are mechanically actuated to deliver compressions at a selected rate and depth.

Known mechanical chest compression devices depend on accurate placement of the compression device over the lower half of the patient's sternum. However, few patient's hearts are actually located at the lower half of the sternum, and most are located to the left of the sternum. Since known devices are designed to provide maximum compressions to the sternal area of the chest they may not be easily repositioned when it is determined that chest compressions are not providing adequate blood flow to the patient's tissues. In addition, variations in anatomy between patients may further reduce the efficacy of compressions, despite adhering to recommended placement of the device relative to a patient's external anatomy. Therefore, such known mechanical compression devices may not be at an optimal location to compress the left ventricle sufficiently.

Investigators have demonstrated findings that a mere fifth of all mechanical compressions are stimulating the target compression site of the left ventricle. This results in suboptimal CPR in 80% of cases where mechanical assistance is employed. Location, depth, and angulation of the piston have been suggested as key reasons for insufficient compression location.

The American Heart Association recommends performing compressions for patients in cardiac arrest in the lower half of the sternum and therefore current mechanical support devices are constructed to provide maximum impact to that area.

Another problem with known mechanical chest compression devices is that they apply compressions regardless of the patient's condition. Once ROSC is achieved, continued compressions are no longer necessary. Known mechanical chest compression devices rely on medical personnel to determine ROSC, for example, by palpating patient's carotid artery and to manually turn off the compressions.

References identified at pages 9-11 of U.S. Prov. Appl. No. 63/394,468, filed Aug. 2, 2022 are each incorporated by reference herein.

### SUMMARY

The present disclosure provides a device and method for providing mechanical CPR that address these and other problems with known devices and techniques.

According to one embodiment of the disclosure, a CPR system includes a mechanical chest compression device connected with and controlled by a blood flow monitor that detects one or more parameters related to the circulation of the patient being treated. These parameters include instantaneous flow rate and blood flow direction. The blood flow monitor provides feedback to the CPR device. According to one aspect, operation of the CPR device is adjusted to optimize blood flow parameters. According to a further aspect, the parameters include end tidal carbon dioxide level and oxygen saturation.

According to one aspect, the device for monitoring circulation is an ultrasound transducer to monitor arterial blood flow patterns. The transducer determines a rate of blood flow while compressions are applied, for example, using a Doppler shift to determine the speed and direction at which blood flows through the artery. For a patient experiencing cardiac arrest, the flow of blood in the artery will depend, at least partially, on how effectively compressions applied by the mechanical chest compression device to the patient's left ventricle. According to one embodiment, the transducer is applied to an artery, such as the femoral or carotid artery. The device monitors the velocity of blood in the artery as compressions are applied. According to one aspect, the system includes a signaling device to alert medical personnel that the mechanical CPR is not being performed optimally. In response to the signal, medical personnel adjusts the CPR device. According to one aspect, medical personnel may reposition the CPR device to more closely align with the patient's left ventricle to maximize the volume of blood expelled with each compression.

According to a further embodiment, the system includes a positioning mechanism connected with the CPR device that repositions the compression apparatus relative to the patient's chest in response to signals from the blood flow monitor. The system repositions the CPR device relative to the patient's left ventricle to provide an optimized blood flow parameter (e.g., arterial flow rate when a compression is applied). In addition to positioning the device above the left ventricle, according to a further aspect, the stroke distance of the mechanical chest compression device may also be adjusted, based on parameters measured by the blood flow monitor.

As set forth below, there is disclosed an improved automated CPR device. This device applies chest compressions at a prescribed rate to a patient receiving CPR. It is an improvement over known automated CPR devices in that it allows the location of the compression piston to be optimized to more effectively apply compressions to the left ventricle, thereby increasing the blood volume displaced to more effectively maintain life support and achieve a return of spontaneous circulation (ROSC).

According to a further aspect, the blood flow monitor determines that the patient has responded to CPR and has achieved ROSC. ROSC may be determined by detecting that arterial blood flow has changed from bi-directional flow in response to chest compressions to unidirectional flow. According to one aspect, once ROSC is detected, the device ceases compression. Alternatively, the system may generate an alert to medical personnel to turn off the mechanical compressions.

According to one embodiment, the compression piston of the automated CPR device is supported by one or more moveable arms that allow the position of the piston with respect to the patient to improve the efficacy of chest compressions during CPR.

According to one embodiment the efficacy of chest compressions is monitored by detecting a change in the pattern of blood flow as compressions are applied. The speed and direction of blood flow may be monitored using an ultrasonic transducer, such as a Zonare phased array ultrasound transducer (ZONARE Medical Systems, Inc.). As described below, it is disclosed that ROSC can be detected by monitoring blood flow patterns in, for example, the femoral or carotid artery using an ultrasound transducer. According to one embodiment, ROSC is detected by identifying a change from a bi-directional arterial flow to a unidirectional flow or patient-generated flow using spectral Doppler techniques. A signal is generated in response to the detection of the change in arterial blood flow pattern. According to one embodiment, this signal causes an indicator, such as an audible signal or light, to alert medical personnel of ROSC.

According to one embodiment, the ultrasonic transducer may be in the form of a patch. The patch may be applied near the patient's femoral or carotid artery.

According to a further embodiment, there is disclosed an integrated closed-loop system with an ultrasound detector that feeds into the mechanical CPR embodiment. Signals from the ultrasound transducer, such as the Zonare transducer, are analyzed and the results of this analysis are provided to the automated CPR device as a control signal. According to a further embodiment, this control signal is used by the automated CPR device to reposition the compression piston by means of movable arms. According to one embodiment, the efficacy of the repositioning of the CPR device is determined, based on changes to the transducer signal. In one embodiment, the efficacy of CPR being administered by the CPR device is communicated to personnel treating the patient and those personnel manually reposition the moveable arms of the CPR device to improve ventricular compressions.

According to a still further embodiment, the transducer signal is monitored to detect ROSC and a control signal is sent to the automated CPR device to cease chest compressions once ROSC is achieved.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows a close-loop mechanical CPR system according to an embodiment of the disclosure;

FIG. 2 shows a front view of a close-loop mechanical CPR system according to another embodiment of the disclosure;

FIG. 3 shows a top view of the system of FIG. 2;

FIG. 4 shows a side view of the system of FIG. 2;

FIG. 5 shows a perspective view of the system of FIG. 2 in an open configuration to facilitate placement of a patient in the apparatus; and

FIG. 6 shows a perspective view of the system of FIG. 2 in an operating configuration with a patient place in the apparatus.

### DETAILED DESCRIPTION

Embodiments are described in terms of treatment of a human patient. The disclosure is not limited to devices to treat humans and is applicable to perform veterinary procedures on animals.

According to one embodiment, a mechanical chest compression device with a centrally located compression piston is attached to moveable arms that connect to a backboard located under the patient's chest/upper back. The device allows the treating CPR providers to move the center compression piston easily during CPR to improve ventricular contractility. The center compression piston is attached to moveable arms. According to some embodiments, the arms allow the center of the piston to be relocated to improve ventricular contractility while CPR is being administered. The moveable arms attach to a backboard device placed under the patient. The arms connect to a compression piston driven by a drive mechanism. Strokes of the piston deliver chest compressions to provide CPR during cardiac arrest.

According to one embodiment, arms supporting the piston mechanism connect to the back board on opposite sides of the patient's chest with a compression device located in the center. According to one embodiment, a button is provided on the device to initiate compressions. According to one embodiment, a mechanical chest compression device provides about 110 compressions per minute at a depth of about 2.2 inches.

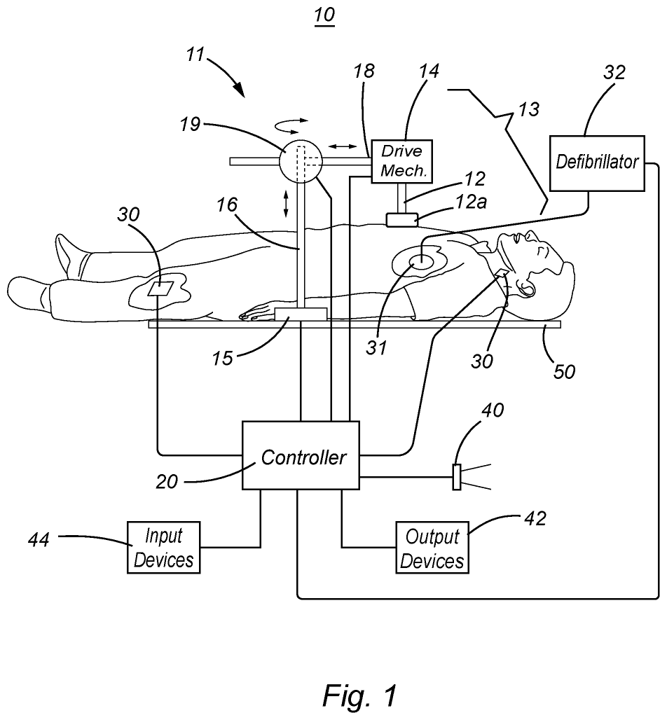

FIG. 1 shows a mechanical CPR system 10 according to embodiments of the disclosure. Compression assembly 13 is supported by frame 11. Compression assembly 13 includes a chest contact pad 12a on piston shaft 12. Drive mechanism 14 is connected with the piston shaft 12. Controller 20 is operatively connected with drive mechanism 14. Signals from controller 20 cause drive mechanism 14 to actuate piston shaft 12 to push chest pad downward to generate a rescue compression.

Drive mechanism 14 is supported by a frame 11 comprised of an arm 18 and vertical support 16. Positioning mechanism 19 is provided between arm 18 and support 16 and moves arm 18 in the horizontal and vertical directions. According to one embodiment, vertical support 16 is connected with back board 50. According to one embodiment, vertical support 16 is connected with rotational positioning mechanism 15 to rotate arm 18 about the vertical axis.

According to one embodiment, first positioning mechanism 19 drives arm 18 horizontally, as shown in FIG. 1. First positioning mechanism 19 is controlled by controller 20 to reposition chest pad 12a relative to the patient's heart while chest compressions are applied, as will be explained below. According to one embodiment, first positioning mechanism 19 comprises a rack disposed on arm 18 and a motor including a pinion gear fixed with mechanism 19 and engaged with the rack. Controller 20 sends signals to operate the motor to move compression assembly 13 to reposition the location where chest compressions are applied to the patient by pad 12a.

First positioning mechanism 19 is supported by vertical support 16. According to one embodiment, first positioning mechanism 19 includes a mechanism controlled by controller 20 to move the mechanism 18, and hence drive mechanism 14, piston 12 and chest pad 12a in the vertical direction. According to one embodiment, vertical positioning mechanism also comprises a rack-and-pinion arrangement whereby rotation of a motor connected with a pinion gear drives mechanism 19 upward to downward along a rack connected with vertical support 16.

According to one embodiment of the disclosure, vertical support 16 is supported by rotational positioning mechanism 15. Rotational positioning mechanism 15 includes a motor controlled by controller 20 to rotate vertical support 16 about a vertical axis. Positioning mechanisms 15, 18 allow controller 20 to adjust the position of the drive mechanism 14, piston 12, and chest pad 12a relative to the patient while CPR is being administered.

According to another embodiment, instead of providing mechanical positioning mechanism 15, 19 controlled by controller 20, frame 11 includes manual positioning mechanisms that allow medical personnel to reposition chest pad 12a relative to the patient during CPR treatment. One or more handles and position locks are provided on arm 18, support 16, and back board 50 that allow medical personnel to move compression assembly 13 into a desired configuration to improve the delivery of chest compressions.

Controller 20 is connected with one or more blood flow detectors 30. According to one embodiment, blood flow detectors 30 detect parameters related to blood flow in the patient's artery, such as the femoral or carotid artery. According to embodiments of the disclosure, detectors 30 detect parameters including the velocity of arterial blood flow and blood flow direction. According to one embodiment, detectors 30 are Doppler ultrasound detectors that determine blood velocity and direction using sonic energy. According to one embodiment, in addition to detectors 30 for monitoring blood flow, other types of detectors may be provided to monitor other physiological parameters such end tidal carbon dioxide level and oxygen saturation. Signals from these other detectors are also provided to controller 20.

Also connected with controller 20 are one or more input devices 44 and output devices 40, 42. According to one embodiment, an audio speaker 40 is connected with controller 20 that allows audible signals to be communicated to medical personnel, for example, to direct personnel to manually reposition the apparatus to improve ventricular contractility. Controller 20 may also be connected with an input device 44, such as a touchscreen, keyboard, or switches.

Also connected with controller 20 is display 42. Display 42 allows controller 20 to display parameters relevant to the administration of CPR and to alert medical personnel to conditions, such as ROSC.

According to one embodiment, detectors 30 determine a blood flow direction during the administration of chest compressions. Prior to ROSC, arterial blood flow during cardiac arrest is bi-directional, with blood flowing away from the heart as the left ventricle is compressed during a chest compression and with blood flowing back toward the heart as the left ventricle rebounds between chest compressions. Once ROSC is achieved, arterial blood flow becomes unidirectional, substantially unidirectional, or develops irregularity from patient-generated blood flow in addition to compression-generated blood flow. According to one embodiment, controller 20 monitors signals from detector 30 and, when ROSC is detected, controller 20 causes drive mechanism 14 to cease chest compressions. According to another embodiment, instead of ceasing compressions automatically, controller 20 generates an alert signal via speaker 40 and/or display 42 instructing medical personnel to cease CPR, for example, by disabling drive mechanism 14.

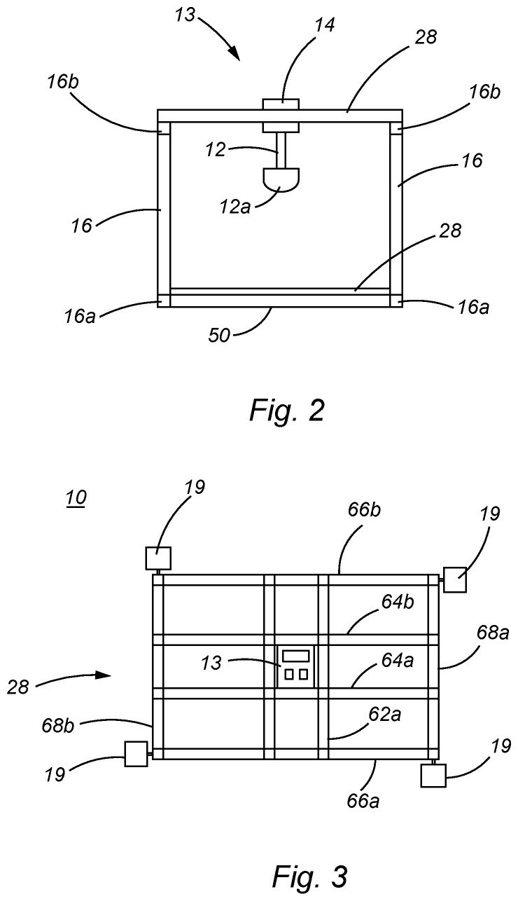

FIGS. 2-6 show a mechanical compression system 10 according to a further embodiment of the disclosure. FIG. 2 is a front view of system 10. Backboard 50 forms base for the device. Backboard 50 may be formed from high density polyethylene or other material suitable to support a human patient. According to one embodiment, backboard 50 is formed from materials similar to those used to form known backboards used by emergency medical personnel.

According to one embodiment, a layer of anti-slip padding 28 is provided on the top surface of backboard. Padding 28 may be formed from a material that is easily cleaned and is suitable to contact human skin.

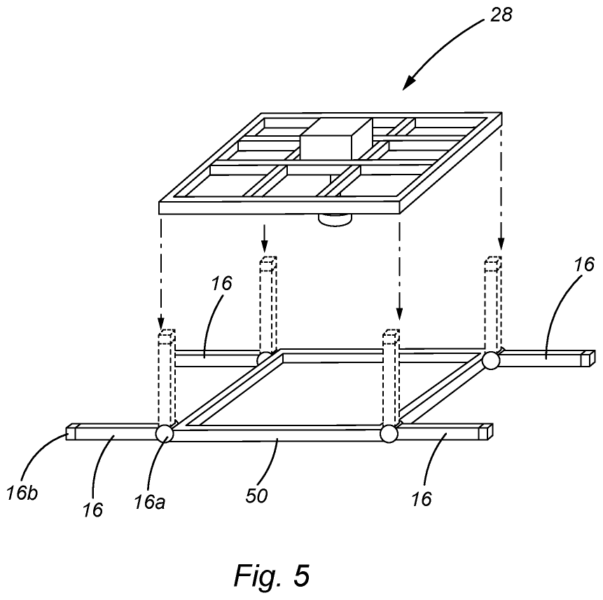

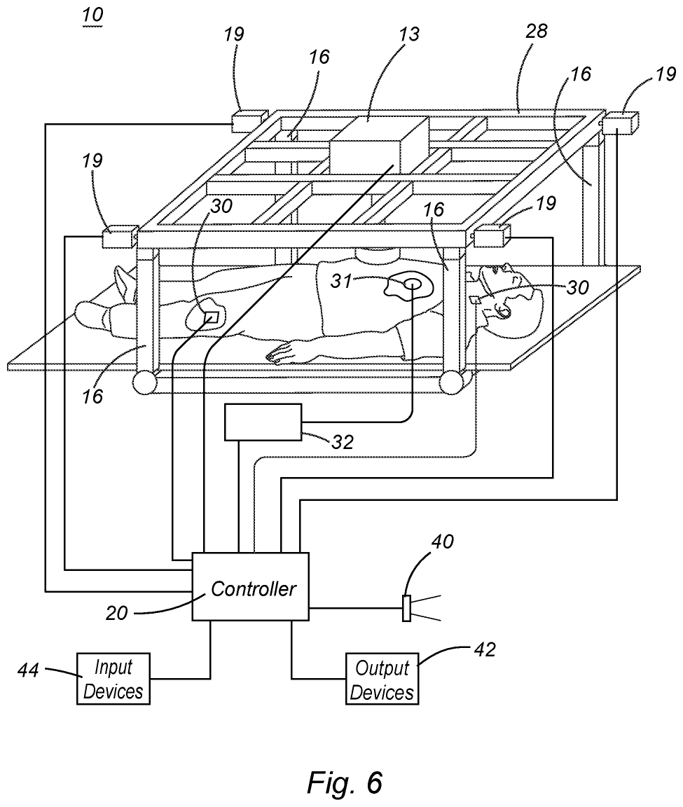

Connected with backboard 50 are a plurality of vertical supports 16. As can be seen in the perspective view in FIGS. 5 and 6, four vertical supports are provided in this embodiment. According to one embodiment, vertical supports 16 are connected with backboard 50 by a respective plurality of hinges 16a. Hinges 16a each include a mechanism to releasably lock vertical supports 16 in a vertical configuration, as shown in FIGS. 2-4 and 6. Solid lines in FIG. 5 shows vertical supports 16 rotated downward to open the device to facilitate positioning a patient within the device for treatment. Phantom lines in FIG. 5 show supports 16 in their vertical, locked position. According to one embodiment, hinges 16a connect vertical supports 16 with backboard 50 at the corners of the backboard. Vertical supports 16 are formed from a light weight, high strength material, such as titanium or carbon fiber.

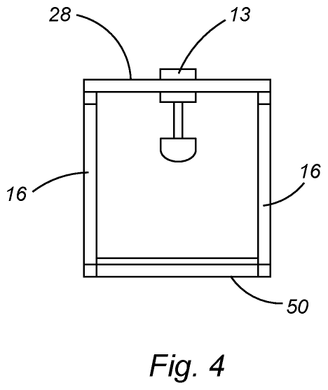

Vertical supports 16 each include a locking mechanism 16b at the top end in the configuration of FIG. 2. As shown in FIGS. 2 and 4, positioning mechanism 28 is connected with the top ends of vertical supports 16 by locking mechanisms 16b. Positioning mechanism 28 can be unlocked from vertical supports 16 and disconnected, as shown in FIG. 5 to facilitate positioning a patient on the device.

FIG. 3 shows a top view of system 10. Positioning mechanism 28 comprises four movable arms 62a, 62b, 64a, 64b that are supported by rails 66a, 66b, 68a, 68b. Each of the rails includes a drive mechanism 19 for moving the ends of arms 62a, 62b, 64a, 64b along the rails. As shown in FIG. 6, controller 20 provides signal to the drive mechanisms 19 to reposition compression assembly 13, as will be described below.

According to one embodiment, the drive mechanisms 19 are each comprised of a worm screw disposed along rails 66a, 66b, 68a, 68b. The worm screws are each rotatably driven by an electric motor. A threaded nut connected with the ends of each arm is threaded onto the worm screws. Rotation of the worm screw drives the nut, and hence the attached arm 62a, 62b, 64a, 64b linearly along the rails. The disclosure is not limited to driving arms 62a, 62b, 64a, 64ba along rails 66a, 66b, 68a, 68b using a worm screw drive. Other methods for moving the arms along the rails know to those of skill in the field of the invention can be used, for example, rack-and-pinion drives, continuous belt drives, and the like.

Positioned between arms 62a, 62b, 64a, 64b is compression assembly 13. As shown in FIG. 2, compression assembly 13 includes chest pad 12a. According to one embodiment, chest pad 12a is spherical or hemispherical and is formed from a complaint material such as silicone. Chest pad 12a deforms when chest compressions are applied, distributing the force of the compressions over a greater surface of the patient's chest to reduce the risk of injuries such as rib fractures and internal bleeding. According to one embodiment, chest pad 12a is formed from a non-conductive material to provide electrical isolation between the body of the patient and system 10. The patient may be treated using high energy defibrillation pulses. By electrically isolating the patient from the device by using an insulating chest pad 12a, this may reduce the risk that high energy defibrillation current will be conducted through system 10 and injure medical personnel treating the patient.

As with previous embodiments, chest pad 12a is driven by piston 12 connected with drive mechanism 14. Drive mechanism 14 may be an electrical solenoid for driving piston 12 upward and downward. According to one embodiment, drive mechanism 14 includes an electrical power source, such as a rechargeable battery. According to other embodiments, instead of or in addition to a battery, system 10 includes a connection to an outside source of power, such as from electrical mains or a vehicle power supply.

According to one embodiment, controller 20 is connected with one or more detectors 30 for monitoring physiological parameters of the patent in response to chest compressions. According to one embodiment, detector 30 is an ultrasonic blood flow detector. According to another embodiment, other detectors, such as detectors for monitoring carbon dioxide exhaled by the patient (capnography) and to measure blood oxygen saturation (pulse oximetry) communicate physiological parameters to controller 20.

According to one embodiment, controller 20 receives signals from defibrillator 32. Defibrillator 32 collects physiological information, including heart rhythm information. Defibrillator 32 delivers electric shocks to the patient's heart through a plurality of electrodes 31 to help restore normal rhythm. According to one embodiment, defibrillator 32 provides a signal to controller 20 in advance of delivering a shock. In response to this defibrillation signal, controller 20 briefly pauses chest compressions.

According to another embodiment, defibrillator 32 is connected with blood flow monitors 30 and other physiological sensors to gather and process data to determine efficacy of chest compressions delivered by compression assembly 13. According to one embodiment, defibrillator 32 analyzes one or more of a patient's end tidal carbon dioxide level, pulse, oximetry level, and blood pressure. Based on this analysis, defibrillator 32 determines parameters related to the efficacy of the chest compressions and communicates those parameters to controller 20.

According to a further embodiment, defibrillator 32 is connected with blood flow monitors 30 to detect blood flow direction in response to chest compressions. Defibrillator 32 determines ROSC by detecting a change in arterial blood flow from bi-directional to unidirectional and signals controller 20 to cease compressions.

According to one embodiment, compression assembly 13 may be positioned manually in the vertical direction relative to positioning mechanism 28. Compression assembly 13 includes a releasable lock that allows medical personnel to raise and lower the drive assembly relative to the backboard 50 and lock the drive mechanism into a fixed vertical position. For example, a button may be provided that engages and disengages with features on arms 62a, 62b, 64a, 64b to allow manual positioning of assembly 13 in the vertical direction.

Likewise, a releasable locking system between arms 62a, 62b, 64a, 64b and the drive mechanisms in rails 66a, 66b, 68a, 68b allows medical personnel to disengage the arms from the drive mechanism to move compression mechanism to a desired horizontal position manually. Once in position, the locking system is engaged so that movement of compression mechanism 13 is performed by the drive mechanisms under control of the controller 20.

Use of a device according to an embodiment of the disclosure will be explained with reference to FIGS. 2-6. Initially, positioning mechanism 28 is removed from vertical supports 16 and the supports are in their folded down position, as shown in FIG. 5. The patient is placed on backboard 50. Vertical supports 16 are raised to their upright positions and hinges 16a are locked. Positioning mechanism 28 is then connected with locks 16b at the tops of vertical supports 16, as shown in FIG. 6.

During initial placement the piston 12 and chest pad 12a are positioned over the lower half of the patient's sternum. Medical personnel unlock arms 62a, 62b, 64a, 64b from their respective drive mechanisms 19 so that compression assembly 13 can be moved manually to a position above the patient's lower sternum and raise or lower assembly 13 until the chest pad 12a is in contact with the patient's chest. Arms 62a, 62b, 64a, 64b are locked with the drive mechanisms 19 in rails 66a, 66b, 68a, 68b so that controller 20 controls the position of compression mechanism 13 with respect to the patient.

According to one embodiment, one or more blood flow detectors 30 are attached to the patient, for example, over the femoral and/or carotid artery. According to another embodiment, medical personnel connect the patient with detectors to monitor other physiological parameters including end tidal carbon dioxide level and oxygen saturation.

Medical personnel start chest compressions by actuating input device 44, for example, by pressing a button. Controller 20 causes compression assembly 13 to deliver chest compressions at a selected rate, for example, about 110 beats per minute, and selected depth, for example, about 2.2 inches.

According to one embodiment, medical personnel actuate input device 44 to perform closed-loop CPR. Controller 20 monitors signals from detectors 30 to determine the efficacy of chest compressions. Controller 20 includes an algorithm that tests the quality of chest compressions being delivered during defined intervals (approximately 20 seconds) at several pre-defined locations by actuating drive mechanisms 19 to move arms 62a, 62b, 64a, 64b to reposition compression assembly 13 to different positions on the patient's chest. According to one embodiment, at each location the algorithm measures, in order of importance: 1) Doppler blood flow parameters including blood flow velocity and direction, 2) end tidal carbon dioxide level, and 3) oxygen saturation. The algorithm optimizes these physiological parameters by moving compression assembly 13 until an optimum location to apply compressions is achieved.

While illustrative embodiments of the disclosure have been described and illustrated above, it should be understood that these are exemplary of the disclosure and are not to be considered as limiting. Additions, deletions, substitutions, and other modifications can be made without departing from the spirit or scope of the disclosure. Accordingly, the disclosure is not to be considered as limited by the foregoing description.

We claim:

1. A device for administering cardiopulmonary resuscitation comprising:
a chest contact pad;
a controller;
a compression assembly mechanically connected with the contact pad and operatively connected with the controller, wherein the compression assembly is adapted to move the contact pad in a first direction in response to a compression signal from the controller;
a frame supporting the drive mechanism, wherein the frame comprises one or more positioning mechanisms connected with the controller, and wherein the one or more positioning mechanisms move the compression assembly and contact pad relative to the frame based on a position signal from the controller.

2. The device of claim 1, wherein the frame comprises one or more arms supporting the compression assembly, wherein the positioning mechanisms are connected with respective ones of the arms, and wherein the positioning mechanisms are adapted to move the position assembly and contact pad relative to a thorax of a patient.

3. The device of claim 2, wherein the frame is adapted to support the compression assembly and contact pad above a left ventricle of a human patient.

4. The device of claim 3, wherein the compression assembly moves the contact pad in the first direction in response to the compression signal to deliver one or more chest compressions to the left ventricle.

5. The device of claim 4, further comprising a blood flow detector connected with the controller and coupled with a vascular system of the patient, wherein the detector provides a signal to the controller comprising one or more blood flow parameters of the patient.

6. The device of claim 5, wherein the controller monitors the one or more blood flow parameters in coordination with delivery of the chest compressions, wherein the controller adjusts a compression parameter of the chest compressions in response to the blood flow parameters.

7. The device of claim 6, wherein the controller causes the one or more positioning mechanisms to adjust a position of the chest pad relative to the left ventricle in response to the blood flow parameters.

8. The device of claim 7, wherein the blood flow parameters comprise a blood velocity in an artery and a blood flow direction through the artery.

9. The device of claim 7, wherein the blood flow monitor is a Doppler ultrasound flow monitor.

10. The device of claim 8, wherein the blood flow parameter includes a blood flow direction in the artery, and wherein the controller determines a return of spontaneous circulation (ROSC) based on the blood flow direction.

11. The device of claim 10, wherein ROSC is determined by a change from a bi-directional blood flow to a unidirectional blood flow.

12. The device of claim 10, wherein, when ROSC is detected, the controller signals the compression assembly to cease the chest compressions.

13. The device of claim 10, further comprising an indicator connected with the controller, wherein the indicator is adapted to alert medical personnel when ROSC is detected.

14. The device of claim 13, wherein the indicator generates one or more of a visual and an audible alert signal when ROSC is detected.

15. The device of claim 7, wherein a least one of the one or more positioning mechanisms comprises a manual positioner, the device further comprising an output device connected with the controller, wherein the output device communicates instructions to medical personnel to reposition the compression assembly relative to the left ventricle based on the blood flow parameters.

16. The device of claim 3, further comprising a backboard connected with the frame, wherein the thorax is positioned between the contact pad and the backboard.
